(19) United States
(12) Patent Application Publication
(10) Pub. No.: US 2018/0260903 A1
(43) Pub. Date: Sep. 13, 2018

(54) COMPUTERIZED MACHINE LEARNING BASED RECOMMENDATIONS

(71) Applicant: Brian Callery, Rockville, MD (US)

(72) Inventor: Brian Callery, Rockville, MD (US)

(21) Appl. No.: 15/915,768

(22) Filed: Mar. 8, 2018

Related U.S. Application Data
(60) Provisional application No. 62/469,630, filed on Mar. 10, 2017.

(51) Int. Cl. G06Q 40/06; G06N 99/00; G06F 17/30

(52) U.S. Cl. CPC G06Q 40/06; G06F 17/30979; G06N 99/005

(57) ABSTRACT

A machine learning based recommendation for a desired strategy is generated for a user. User data pertaining to previous user decisions pertaining to capitalization is received. Data that is similar to the received user data is automatically queried. The similar data may be useful for generating the recommendation for the desired strategy. An objective that constrains the desired strategy for capitalization is received. The similar user data and the objective are automatically analyzed to generate the recommendation for the desired strategy based on machine learning from the similar user data.

### CROSS-REFERENCE TO RELATED APPLICATIONS

This application claims priority to U.S. Provisional Patent Application Ser. No. 62/469,630, entitled “Computerized Capitalization Management Including Recommendations Based on Machine Learning” and filed Mar. 10, 2017, the disclosure of which is incorporated herein by reference in its entirety.

### BACKGROUND

### 1. Technical Field

Present invention embodiments relate to machine learning, and more specifically, to machine learning for recommending or providing strategies, such as a user capitalization strategy.

### 2. Discussion of the Related Art

A capitalization table is a record of shareholders/stakeholders of a company and corresponding shareholder/stakeholder securities data. For instance, capitalization tables may include shareholder/stakeholder pro-rata ownership of securities issued by the company (e.g., equity shares, preferred shares, options, etc.), and the various purchase prices associated with the securities. Capitalization tables can be used to monitor an increasingly intricate company capital structure as the company expands.

Many entrepreneurs do not understand deal terms when raising capital for the company or granting shares or options, and often fail to fully appreciate the dynamic impact of deal terms on ownership percentages and eventual exit payouts. For example, terms relating to preferred options, certain debt financing conversions, and liquidation preferences (particularly with participating preferred stock) are frequently misunderstood. However, these terms can have a dramatic impact on ownership and exit payouts. Furthermore, many entrepreneurs do not fully understand what common/standard deal terms are, as applied to their specific situations. Therefore, many of these entrepreneurs feel unsure about the fairness of investment deals they receive.

Accordingly, most companies rely on professionals (e.g., lawyers and accountants) who use static file systems, to manage capitalization data and deal terms.

### SUMMARY

According to one embodiment of the present invention, machine learning provides a recommendation for a desired strategy, such as a user capitalization strategy. A machine learning system manages capitalization details, and generates forecasts of potential future capitalization needs. Recommendations may be provided for a user capitalization strategy, including accepting user capitalization data pertaining to previous user capitalization decisions, and automatically querying for capitalization data that is relevant to the user capitalization data. The relevant capitalization data may be useful for generating the recommendation for the user capitalization strategy or running forecasts on potential strategies. Embodiments of the present invention further include accepting a user capitalization objective that constrains the user capitalization strategy. The relevant capitalization data and the user capitalization objective are automatically analyzed (e.g., by machine learning) to generate the recommendation for the user capitalization strategy. The recommendation may be based on actual occurrences from the relevant capitalization data or patterns arising from the relevant capitalization data.

### BRIEF DESCRIPTION OF THE DRAWINGS

FIG. 1 is a diagrammatic illustration of an example environment for an embodiment of the present invention.

FIG. 2 is a block diagram illustrating an example capitalization management module in accordance with an embodiment of the present invention.

FIG. 3 is a flow diagram illustrating an example manner of notifying a user of an alert in accordance with an embodiment of the present invention.

FIG. 4 is a flow diagram illustrating an example manner of tracking user progress toward a goal in accordance with an embodiment of the present invention.

FIG. 5 is a flow diagram illustrating an example manner of communicating and sharing user account information in accordance with an embodiment of the present invention.

FIG. 6 is a flow diagram illustrating an example manner of determining whether user input data includes errors or inconsistencies in accordance with an embodiment of the present invention.

FIG. 7 is a flow diagram illustrating an example manner of managing details for, and collaborating with, a plurality of companies in accordance with an embodiment of the present invention.

FIG. 8 is a flow diagram illustrating an example manner of enabling certain user account information to be reviewed and/or verified by another user in accordance with an embodiment of the present invention.

FIG. 9 is a flow diagram illustrating an example manner of making payments for products and/or services in accordance with an embodiment of the present invention.

FIG. 10 is a flow diagram illustrating an example manner of predicting and/or recommending deal terms in accordance with an embodiment of the present invention.

FIG. 11 is a flow diagram illustrating an example manner of constructing model scenarios in accordance with an embodiment of the present invention.

FIG. 12 is a flow diagram illustrating an example manner of providing predictive recommendations for documents in accordance with an embodiment of the present invention.

FIG. 13 is a table illustrating example data gathered via capitalization management techniques in accordance with an embodiment of the present invention.

### DETAILED DESCRIPTION

Techniques described herein are provided that may assist a growing number of companies or other entities with various strategies, such as acquiring growth capital. A collaborative system is provided that employs machine learning to suggest, and forecast the impact of, various capital fundraising strategies and/or associated deal terms. This system allows users to manage company capitalization efforts and make informed decisions relating to capital fundraising strategies. Embodiments provide an automated and fully integrated system capable of recommending strategies (such as customized capitalization strategies) based on machine learning to users and employ techniques to increase computer performance for processing large amounts of data, thereby providing rapid responses.

For example, an invention embodiment includes storage for refining/isolating the appropriate reference data for each user for correlation reference, and further includes storage for refining/isolating aggregate (e.g., global) data to be correlated with user reference data. The system storage and data refinement/isolation may allow retrieval queries to be very specific and easily filtered, thereby minimizing the number of database interactions and amount of data that is transmitted. The storage may update the refined/isolated data as each new dataset is input, thus further minimizing the amount data that is processed and enhancing the process by which the user receives recommendations. Moreover, the storage methods and data refinement systems enable the system to minimize and automatically improve the processing requirements for queries and calculations by segregating and continuously updating user recommendation data as new data is input. The isolation of the recommendation data minimizes the amount of data queried, and continuously performing pattern identification and/or calculations (e.g., when new data is input) minimizes the data processing and calculations done, thereby optimizing the user processing.

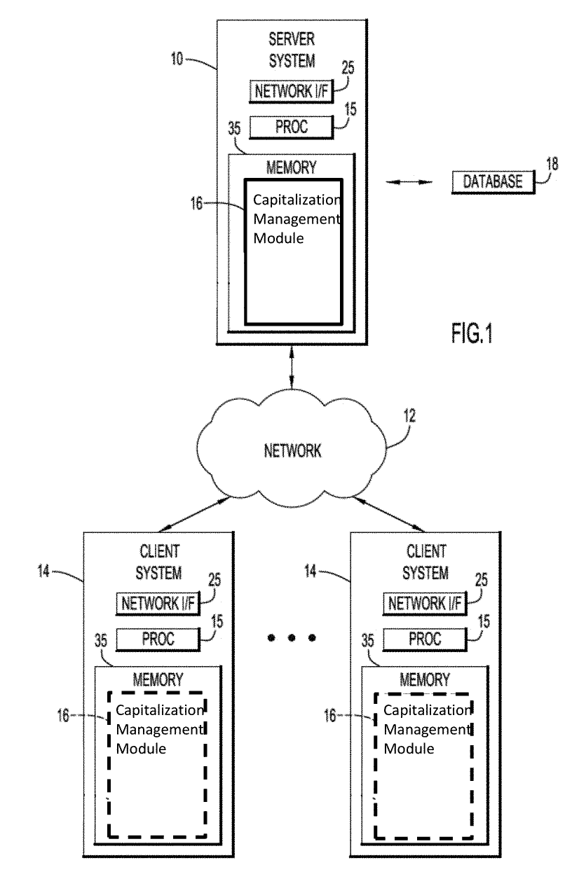

An example environment for use with present invention embodiments is illustrated in FIG. 1. Specifically, the environment includes one or more server systems 10, and one or more client or end-user systems 14. Server systems 10 and client systems 14 may be remote from each other and communicate over a network 12. The network may be implemented by any number of any suitable communications media (e.g., wide area network (WAN), local area network (LAN), Internet, Intranet, etc.). Alternatively, server systems 10 and client systems 14 may be local to each other, and communicate via any appropriate local communication medium (e.g., local area network (LAN), hardwire, wireless link, Intranet, etc.).

Client systems 14 enable users to request a recommendation (e.g., for user capitalization strategy) via server systems 10. By way of example, the server systems include a capitalization management module 16 to enable generation of a recommendation for user capitalization strategy. However, recommendations may be provided for other scenarios. A database system 18 may store various information for generating the recommendation (e.g., capitalization data, etc.). The database system may be implemented by any conventional or other database or storage unit, may be local to or remote from server systems 10 and client systems 14, and may communicate via any appropriate communication medium (e.g., local area network (LAN), wide area network (WAN), Internet, hardwire, wireless link, Intranet, etc.). The client systems may present a graphical user (e.g., GUI, etc.) or other interface (e.g., command line prompts, menu screens, etc.) to enable users to input user capitalization data to the server system 10 or database 18.

Server systems 10 and client systems 14 may be implemented by any conventional or other computer systems preferably equipped with a display or monitor, a base (e.g., including at least one processor 15, one or more memories 35 and/or internal or external network interfaces or communications devices 25 (e.g., modem, network cards, etc.)), optional input devices (e.g., a keyboard, mouse or other input device), and any commercially available and custom software (e.g., server/communications software, capitalization management module 16, browser/interface software, etc.).

Alternatively, one or more client systems 14 may generate a recommendation (e.g., for user capitalization strategy) when operating as a stand-alone unit. In a stand-alone mode of operation, the client system 14 stores or has access to the data (e.g., user capitalization data, etc.), and includes capitalization management module 16 to generate a recommendation for user capitalization strategy. The graphical user (e.g., GUI, etc.) or other interface (e.g., command line prompts, menu screens, etc.) enables users to input user capitalization data to the server system 10 or database 18, and may also enable generation of a recommendation for user capitalization strategy.

Capitalization management module 16 may include one or more modules or units to perform the various functions of present invention embodiments described below. The various modules (e.g., capitalization management module 16) may be implemented by any combination of any quantity of software and/or hardware modules or units, and may reside within memory 35 of the server and/or client systems for execution by processor 15.

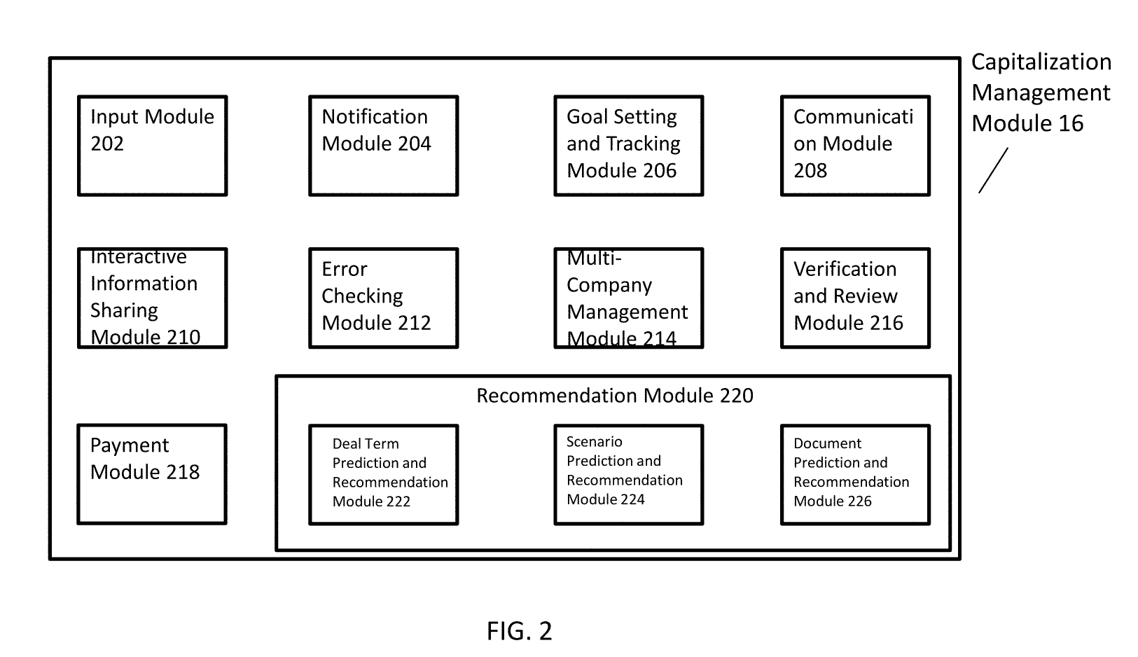

Capitalization management module 16 is further illustrated in FIG. 2. Capitalization management module 16 includes a plurality of modules enabled to perform one or more respective tasks. In an embodiment, capitalization management module 16 includes an input module 202, a notification module 204, a goal setting and tracking module 206, a communication module 208, an interactive information sharing module 210, an error checking module 212, a multi-company management module 214, a verification and review module 216, a payment module 218, and a recommendation module 220.

The input module 202 enables a user to manually input into capitalization management module 16 previous user capitalization data (e.g., shares of stock in a company, secured funding for a company, etc.). Previous user capitalization data may also be obtained automatically (e.g., by pulling information from a spreadsheet, etc.)

The notification module 204 provides an alert that an issue related to user capitalization requires attention. For example, the notification module 204 may provide an alert of an upcoming convertible note maturity date, stock vesting date, etc.

The goal setting and tracking module 206 permits a user to set a goal related to capitalization and track progress toward the goal. Users can input or import their industry and company financial data. When the user inputs their target fundraising goal, or based on the predicted next likely amount raised, the system queries a database (e.g., database 18) of investors (e.g., venture capitalists, angel inventors, etc.) to identify investors that typically invest amounts that align with the company's goal or projected amount. The system provides suggestions to the user of potential investors that typically invest in similar companies. The system classifies the company, and matches items, such as their industry, the amounts they are looking to raise (or amounts the system has projected it might raise), etc.

Similar to above, the system also provides a list of companies that have approved public knowledge of their intent to raise capital or just have their information shared, and looking to raise funds to the investors. The system collects data from the investors (or known data about their preferences) and companies who have successfully pitched and been funded by certain investors on the pitch deck, and information needed to pitch those certain investors. The system allows companies, who have pitched certain investors, to rate various types of information as to how critical and successful it was in pitching specific investors (e.g. the system could learn that, for a specific investor, knowing the competitive environment for your company and demonstrating market traction was extremely important while having five years financial projections was not very important).

The system extracts the necessary information from the company's system data to pre-populate an investor presentation, specific to the investors they choose and the information known to be important based on the analytics.

As users use the system, the system learns and improves the speed and accuracy of its recommendations regarding investors and information required for a successful investment pitch presentation, in a similar manner to the other recommendations. For example, the system may employ machine learning to determine relevant information or pitches for an investor. In this case, information selected/rated by a user may be stored, and/or metrics and/or attributes of the selected information (e.g., success, etc.) may be tracked. This data may be processed to learn preferences for successful pitches. Further, the system may employ machine learning to provide additional metrics and/or attributes based on the metrics and/or attributes used for selected information. The system may employ various models to perform the learning (e.g., neural networks, mathematical/statistical models, classifiers, etc.). By way of example, information may be selected, but for some reason, may not produce a desired outcome. The system may learn these aspects and employ them to select and/or recommend pitches/investors.

The communication module 208 is an interactive exchange that enables users to ask questions to, provide feedback for, or post comments for other users. A user may attach details from the user account (e.g., scenario predictions, current or proposed stakeholder distributions, etc.) to the communication. The communications may be public (i.e., any user may view and/or respond to the communication) or private (i.e., only one or more particular users may view and/or respond to the communication).

Interactive information sharing module 210 enables a user to share user account data (e.g., capitalization table and stakeholder details, scenario predictions, goals, etc.) with another user. If the other user has been granted privilege, the other user may collaborate on any and/or all of the user account data. The system may also recommend specific data points that the user should consider sharing with the other user.

Error checking module 212 examines user data for any errors or inconsistencies, and may provide suggestions for correcting the errors or inconsistencies.

The multi-company management module 214 permits a user to manage capitalization data for multiple companies/users. A user may request permission to access/manage another pre-existing user account, or may establish an account for another user. The user and/or other user may grant or revoke access/management permissions.

The verification and review module 216 allows a user to grant permission to another user to verify the user documents, capitalization tables, scenario predictions, etc.

The payment module 218 enables users to pay for documents, services, etc. obtained via the system. Users may also collect investments and pay investors via the payment module 218.

The recommendation module 220 suggests, and predicts the impact of, various capital fundraising strategies and/or associated deal terms. The recommendation module includes a plurality of modules, including a deal term prediction and recommendation module 222, a scenario prediction and recommendation module 224, and a document prediction and recommendation module 226.

Deal term prediction and recommendation module 222 analyzes actual and proposed data relating to deal terms (e.g., terms of a deal relating to capitalization efforts) to provide recommended deal terms, preferably via machine learning. The user may also set certain prediction objectives (e.g., largest capital raised, lowest equity dilution, etc.), in which case the deal term prediction and recommendation module 222 provides recommended deal terms (or a range of deal terms) that are as consistent as possible with the objectives.

Scenario prediction and recommendation module 224 permits users to project the impact of possible fundraising, exit scenarios, etc. Users may save the results of the prediction for subsequent retrieval or sharing. Scenario prediction and recommendation module 224 may compare the outcomes of projected scenarios with current capital structure, and may also compare the respective outcomes of multiple projected scenarios.

The document prediction and recommendation module 226 recommends certain document(s) (e.g., contracts, term sheets, regulatory filings, etc.) that may help user capitalization efforts by analyzing data corresponding to other user documents. The document prediction and recommendation module 226 may suggest information from the user account to populate the document(s) (e.g., deal terms, names, etc.). If the user approves the suggested information, the document is populated with the suggested information. The user may also manually input or override any suggested information.

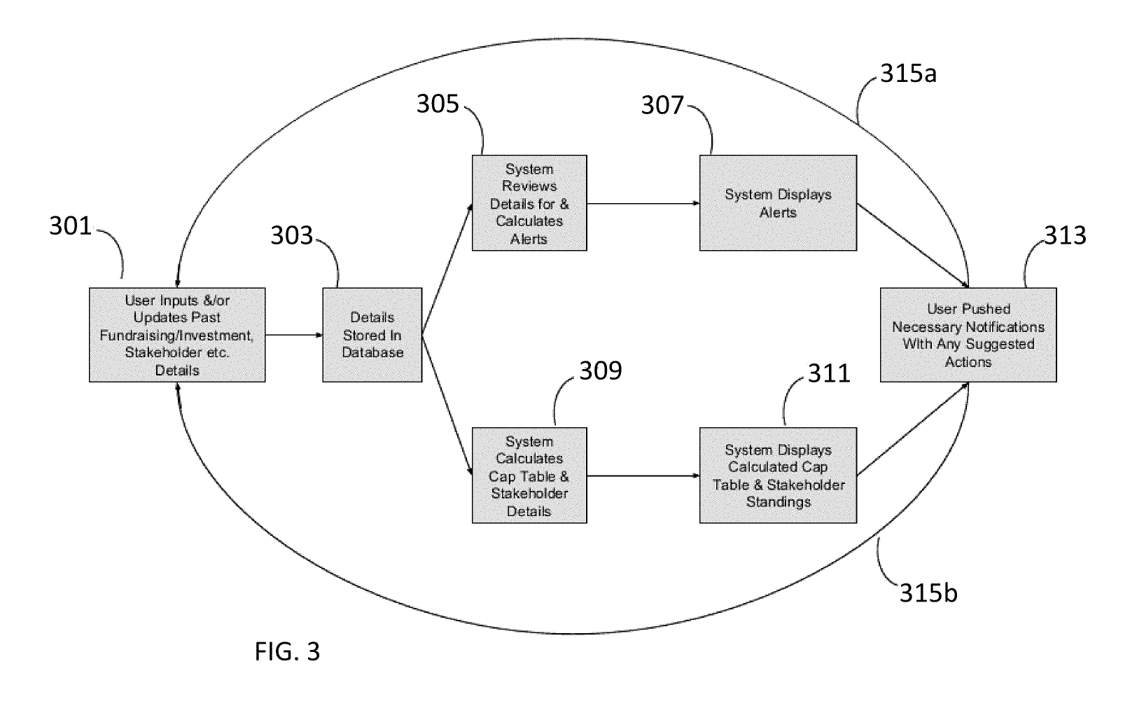

The notification module 204 notifies a user of an alert, as illustrated in the example flow diagram of FIG. 3. Initially, a user inputs previous user capitalization data (e.g., via the input module 202) at block 301. The previous user capitalization data is stored in the system (e.g., at database 18) at block 303. The notification module 204 reviews the previous user capitalization data for issues that trigger an alert (e.g., a convertible note maturity date has past, stakeholder shares will vest within three months, etc.) at block 305. If the notification module 204 determines that there exist one or more issues that warrant an alert, the alert(s) are displayed in the user account at block 307.

The user capitalization data may also be used to calculate user stakeholder standings (e.g., accrued interest on debt, percent of company owned by stakeholder class, percent of company owned by each stakeholder, etc.) at block 309. These user stakeholder standings are displayed in the user account at block 311.

The notification module 204 pushes alerts (e.g., alerts that a convertible note maturity date has past, a threshold amount of interest on debt has accrued, etc.) to the user at block 313. As explained further below, the system may also push suggested actions to the user at block 313. Based on the suggested actions, the user may decide to accept or ignore any suggested actions. The user may also update the previous user capitalization data accordingly via the input module 202 at block 301, as represented by arrows 315a,b.

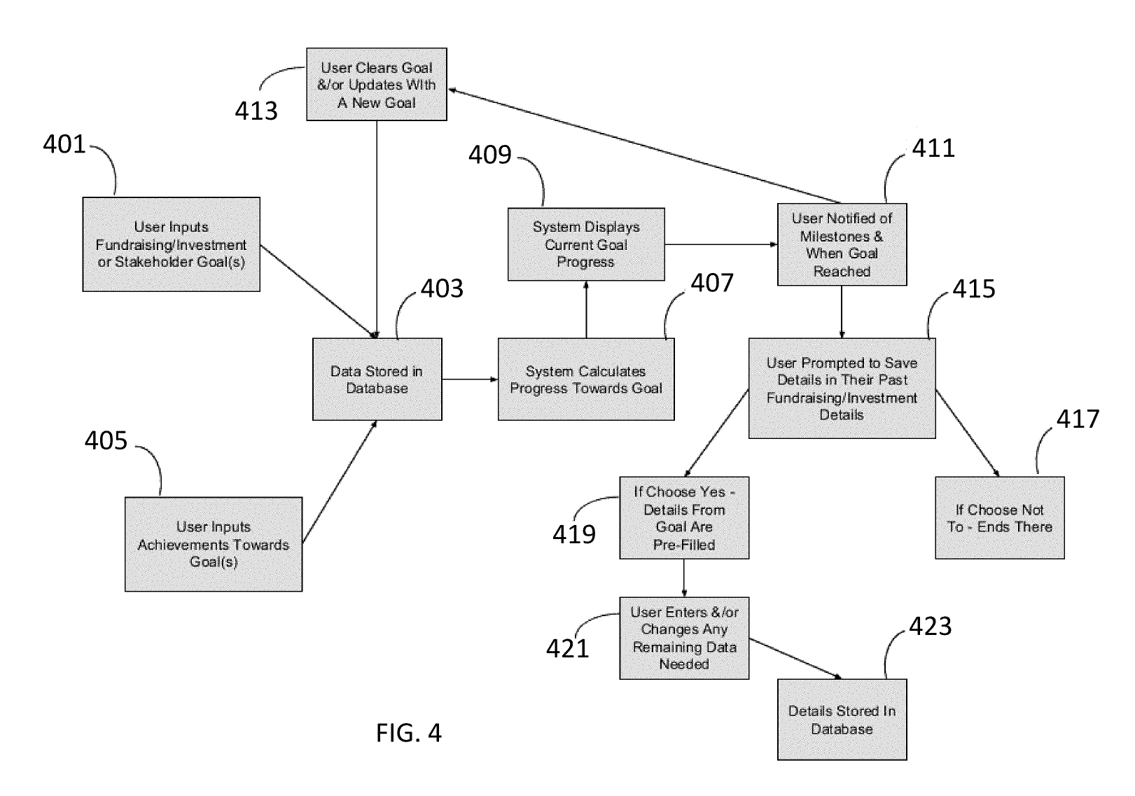

Goal setting and tracking module 206 permits a user to track user progress toward a goal (e.g., a fundraising/investment dollar amount) set by the user. As illustrated in the example flow diagram of FIG. 4, a user initially inputs a goal into the system (e.g., via input module 202) at block 401. The goal is then saved and stored in a database (e.g., database 18) at block 403. The user inputs updated information (e.g., via input module 202) as the user approaches, or is distanced from, the stored goal at block 405. At block 407, goal setting and tracking module 206 uses the updated information to calculate user progress toward the goal. The system displays the user progress at block 409.

When the user reaches certain progress milestones (e.g., 50% of a fundraising/investment dollar amount, when the goal is reached, etc.), the user is notified (e.g., by notification module 204) that the progress milestone was reached at block 411. In response to the notification, the user may clear the goal, update the goal, or set a new goal at block 413. If the user chooses to do so, the database stores the clear/update/new goal information at block 403.

A notification that the goal has been reached may include a prompt to the user to input (e.g., via input module 202) data regarding the achievement at block 415. The user may elect not to input the data at block 417. Alternatively, the user may elect to input the data into the system, in which case the system pre-fills the data that are already known to the system at block 419. The user may accept or change the pre-filled data and enter remaining (i.e., non-pre-filled) data at block 421. The data are stored in a database (e.g., database 18) with the previous goal data at block 423.

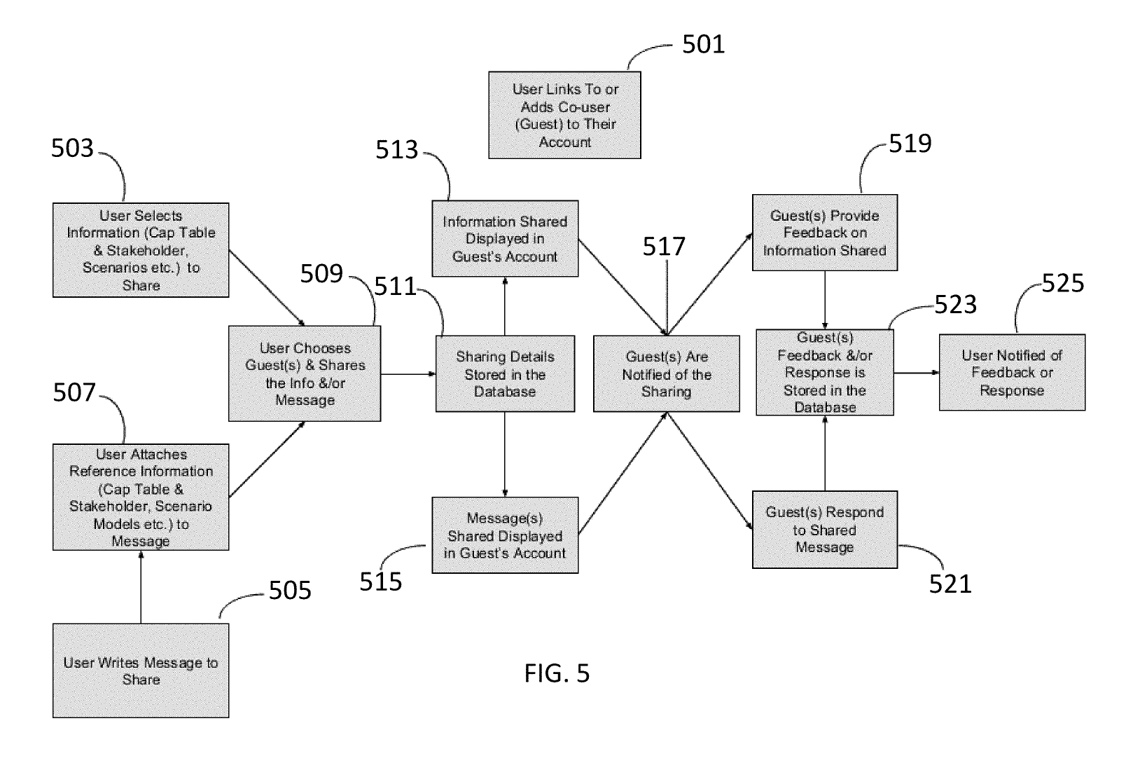

Communication module 208 and interactive information sharing module 210 enable users to communicate and share user account information, as illustrated in the example flow diagram of FIG. 5. A user may “link” to other user accounts by searching the database of existing users and/or manually adding users at block 501. When a user links to another user account, the user can select account information (e.g., capitalization tables, scenario predictions, etc.) to be shared with the other user (block 503) and/or draft a message to be sent to the other user (block 505). The user may attach to the message the account information the user wishes to be shared (block 507). After the message is drafted and/or the account information is selected, the user may select one or more linked user accounts to send the message and/or account information at block 509. The message and/or account information are stored in a database (e.g., database 18) at block 511 before being displayed on the other user account(s) at blocks 513, 515. The other user(s) are notified (e.g., via notification module 204) that the user shared a message and/or account information at block 517. The other user(s) may respond to the message at block 519 and provide feedback on the account information at block 521. The response and/or feedback is stored in the database (e.g., database 18) at block 523 before the user is notified (e.g., via notification module 204) of the response and/or feedback at block 525.

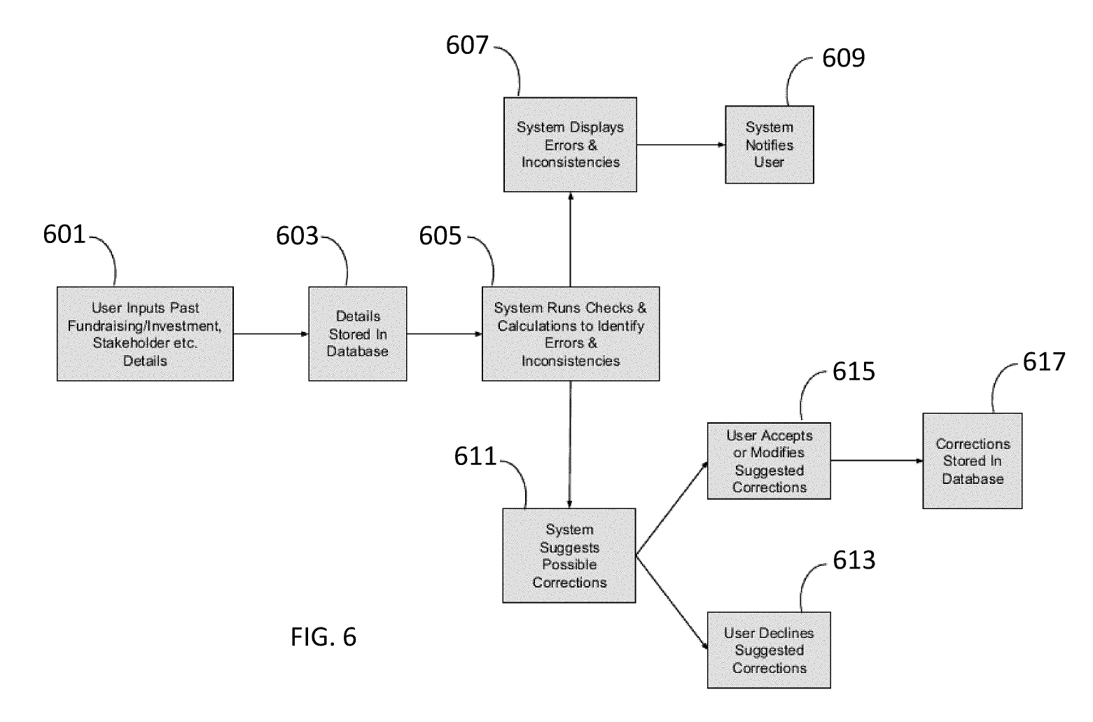

Error checking module 212 analyzes data input by a user to determine whether the user input data includes errors or inconsistencies, as illustrated in the example flow diagram of FIG. 6. A user inputs previous capitalization data (e.g., past fundraising/investments, stakeholder details, etc.) at block 601. The previous capitalization data is stored in a database (e.g., database 18) at block 603. At block 605, error checking module 212 performs a check for errors and/or inconsistencies (e.g., the sum of manually entered individual investor contributions does not equal the manually entered aggregate investor contribution). If any errors and/or inconsistencies are found, the error checking module 212 causes them to be displayed to the user at block 607. The system may also notify (e.g., via notification module 204) the user of the errors and/or inconsistencies at block 609.

The error checking module 212 may also suggest possible corrections to the error and/or inconsistency at block 611. For example, a user might indicate that a convertible debt has not yet matured while indicating elsewhere that the debt was converted to equity. In this circumstance, the error checking module 212 may suggest that the user either indicate that the convertible debt has matured or indicate that the debt was not converted to equity. The user may decline the suggested corrections (block 613) or accept/modify the suggested modifications (block 615). If the user chooses to accept/modify the suggested modifications, the user makes corrections, which are stored in a database (e.g., database 18) at block 617.

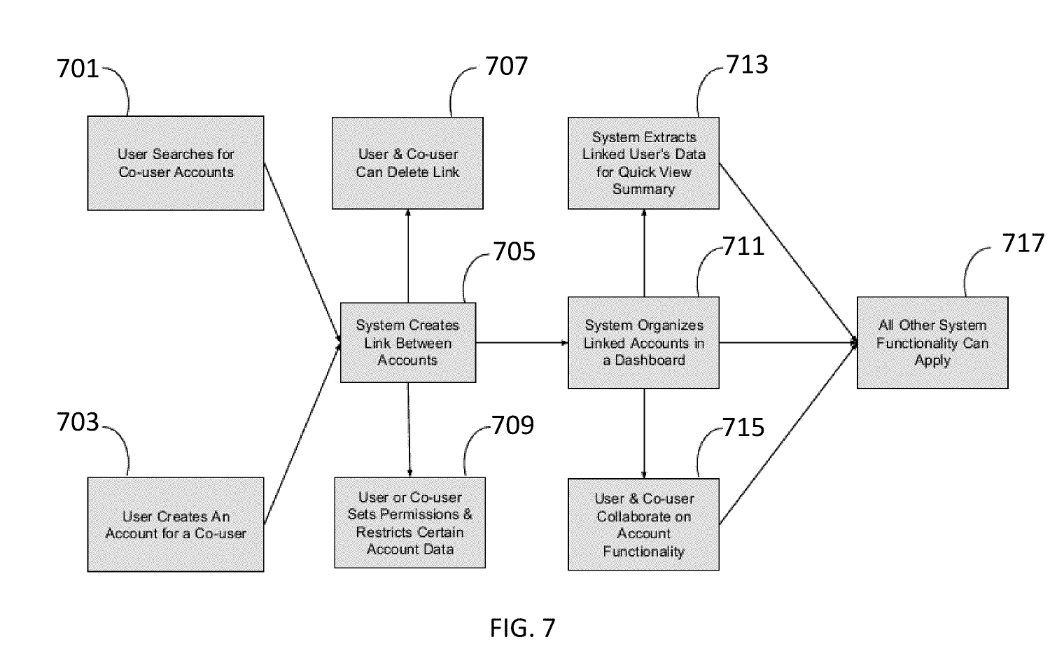

Multi-company management module 214 enables a user to manage details for, and collaborate with, a plurality of companies, as illustrated by the example flow diagram in FIG. 7. The system must first establish links between a user account and other user accounts. The links may be established when a user searches for and selects the other user accounts at block 701. The links may also be established when the user creates accounts for other users not registered in the system, at block 703. Thereafter, the system creates a link between the user account and the other user accounts at block 705. Either linked account may delete the link at block 707, and may set permissions and/or restrictions for certain user account data at block 709.

Once the links are established and approved by both linked users, the multi-company management module 214 organizes the other linked accounts on an organized, centralized dashboard at block 711. The dashboard permits the user to view summaries of account data, shared items, exchange messages, etc. at block 713. By virtue of being linked, the user may collaborate on, manage, and/or edit previous capitalization data (e.g., fundraising/investment details, scenario predictions, tracked goal progress, etc.) for which permission has been granted at block 715. The user may also utilize any other system functionality (e.g., adding guests to a linked user account, sharing data with a guest, etc.), provided permission has been granted, at block 717.

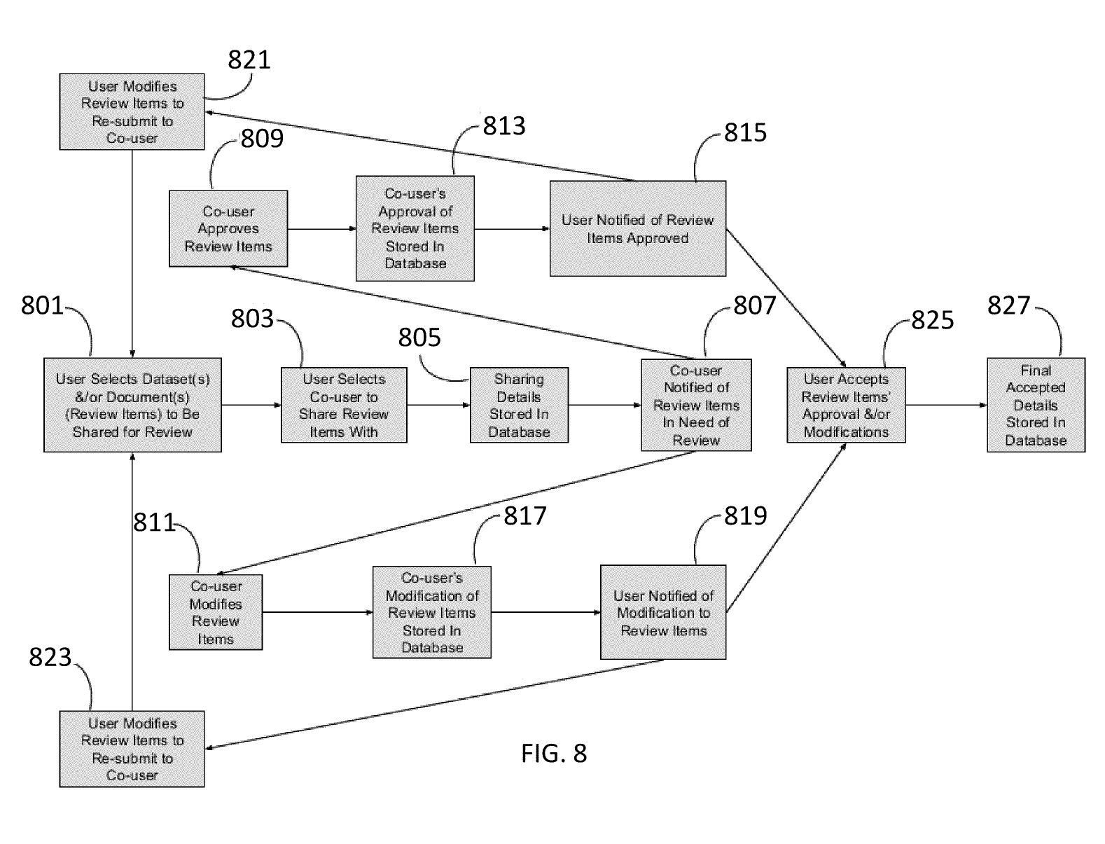

The verification and review module 216 permits a user to request that certain user account information (e.g., past fundraising details, documents, etc.) be reviewed and/or verified by another user, as illustrated by the example flow diagram in FIG. 8. First, the user selects the user account information intended for review/verification at block 801 and the other user who is intended to review the document at block 803. Data associated with the information intended to be shared are stored in a database (e.g., database 18) at block 805 and the other user is notified of the information intended for review/verification at block 807.

The other user may approve/verify the user account information at block 809 or modify the information at 811. If the other user approves/verifies the information, the approval/verification is stored in a database (e.g., database 18) at block 813 and the user is notified of the approval/verification at block 815. If the other user modifies the information, the modification is stored in a database (e.g., database 18) at block 817 and the user is notified of the modification at block 819.

After receiving notification of the approval/verification or modification, the user may modify the user account information for resubmission to the other user (blocks 821, 823), or accept the approval/verification or modification at block 825. If the user resubmits the modified user account information, the user selects the user account information intended for review/verification at block 801 and the process continues as described above. If the user accepts the approval/verification or modification, the accepted user account information is stored in a database (e.g., database 18) at block 827.

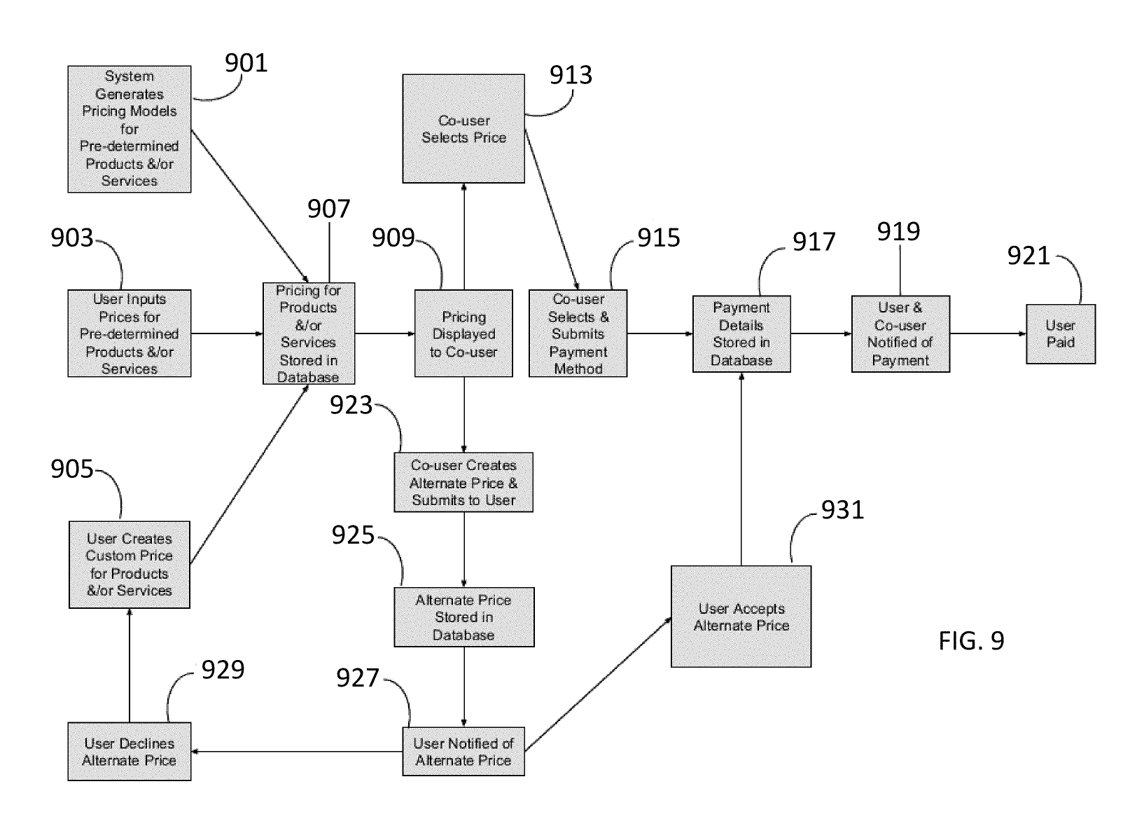

Payment module 218 enables a user to make payments for various products and/or services offered through the system, as illustrated by the example flow diagram in FIG. 9. Products and/or services may be priced in one of three ways. First, at block 901, the system may generate pricing models for pre-determined products and/or services (e.g., document review, etc.). Second, at block 903, a user may modify the pricing models for predetermined products and/or services offered by the user. Third, at block 905, a user may create a price for a custom user product and/or service that is outside the scope of the predetermined pricing models.

Once the pricing scheme is determined, it is stored in a database (e.g., database 18) at block 907, and is displayed to the user purchasing the product and/or service at block 909. The purchasing user may make a counteroffer or accept the offered price. If the purchasing user accepts the offered price at block 913, the purchasing user selects and submits a payment method (e.g., credit card, bank transfer, etc.) at block 915. The payment details are stored in a database (e.g., database 18) at block 917. The purchasing user and the user offering the product and/or service are notified of the payment at block 919, and the offering user is paid at block 921.

If the purchasing user elects to make a counteroffer, the purchasing user inputs an alternate price at block 923. The alternate price is stored in a database (e.g., database 18) at block 925 and the user is notified of the alternate price at 927. The offering user may decline the alternate price at block 929 or accept the alternate price at block 931. If the offering user declines the alternate price, the offering user may make a counter-counteroffer by inputting a new custom price at block 905, and the process continues as described above. If the offering user accepts the alternate price, the payment details are stored in a database (e.g., database 18) at block 917, and the process continues as described above.

As described above, the recommendation module 220 (including deal term prediction and recommendation module 222, scenario prediction and recommendation module 224, and document prediction and recommendation module 226) provides predictive recommendations (e.g., for capitalization management), preferably based on machine learning. The recommendation module may run continuously to analyze data and provide the recommendations, which may be stored for subsequent user access along with user interaction with the data (e.g., whether the user accepted, modified, or declined the recommendations). The system may use the stored data to continuously learn and improve/refine predictive recommendations to those more likely to be accepted by the user.

For example, the system may employ machine learning to determine the predictive recommendations. In this case, recommendations selected by a user may be stored, and/or metrics and/or attributes of the selected recommendation (e.g., success, goals attained, etc.) may be tracked. This data may be processed to learn preferences for successful recommendations. Further, the system may employ machine learning to provide additional metrics and/or attributes based on the metrics and/or attributes used for selected recommendations. The system may employ various models to perform the learning (e.g., neural networks, mathematical/statistical models, classifiers, etc.). By way of example, a recommendation may be selected, but for some reason, may not produce a desired outcome. The system may learn these aspects and employ them to select and/or recommend other strategies.

The deal term prediction and recommendation module 222 compares actual and/or proposed deal terms for a particular user with actual deal terms for other users. The deal term prediction and recommendation module 222 uses the results of the comparison to provide a recommendation to the particular user as to the actual and/or proposed deal terms.

The system may obtain other user actual deal terms by searching for global user data (e.g., data stored in database 18, scraping data from the Internet, importing data from other systems, etc.) that is similar to the user actual or proposed deal terms. For example, the system may scan for global user data related to past investment amounts that fall near (e.g., within a range of) a user anticipated investment amount. The system may then suggest deal terms for the user based on the global user data.

In an example, the system has information indicating that a user has raised three convertible debts over the course of three previous investment rounds for a total convertible debt of two million dollars. In this example, the deal term prediction and recommendation module 222 searches for data corresponding to instances in which users currently on a fourth investment round have raised two million dollars, plus or minus fifty thousand dollars. The deal term prediction and recommendation module 222 then extracts the deal term information corresponding to the users fourth investment rounds and presents the information to the user. For instance, the system may inform the user that, based on the similar investment histories of previous users, the user may expect to raise an equity investment (instead of the convertible debt) of five million in the fourth investment round. The system may further indicate that the range of expected equity investments is between three and ten million dollars.

In the same example, the system may also provide the user with other potential deal terms. For instance, the system may inform the user that, for the previous users fourth investment rounds: the median valuation is twelve and a half million dollars; the range of valuations is between seven and a half million dollars and fifteen million dollars; the median liquidation preference is 1X; the median liquidation preference range is 1X-3X; and the fourth investment round deal terms typically involve non-participating preferred stock, with 65% of the fourth investment round deals involving non-participating preferred stock and 35% involving participating preferred stock.

The deal term prediction and recommendation module 222 may accept any user input to improve the predictive outcome of the deal term prediction and recommendation. For example, user inputs may include the type of company/industry, revenue history, type of fund previously raised (e.g., convertible debt, equity, etc.), amounts of funds previously raised, previous deal terms, type of previous investors (e.g., angel, venture capital, etc.), and others. The system may also provide a variety of outputs and/or recommendations (e.g., recommendations based on the most common results, results having the least dilutive impact, results having the highest valuations or the largest dollar amount raised, etc.).

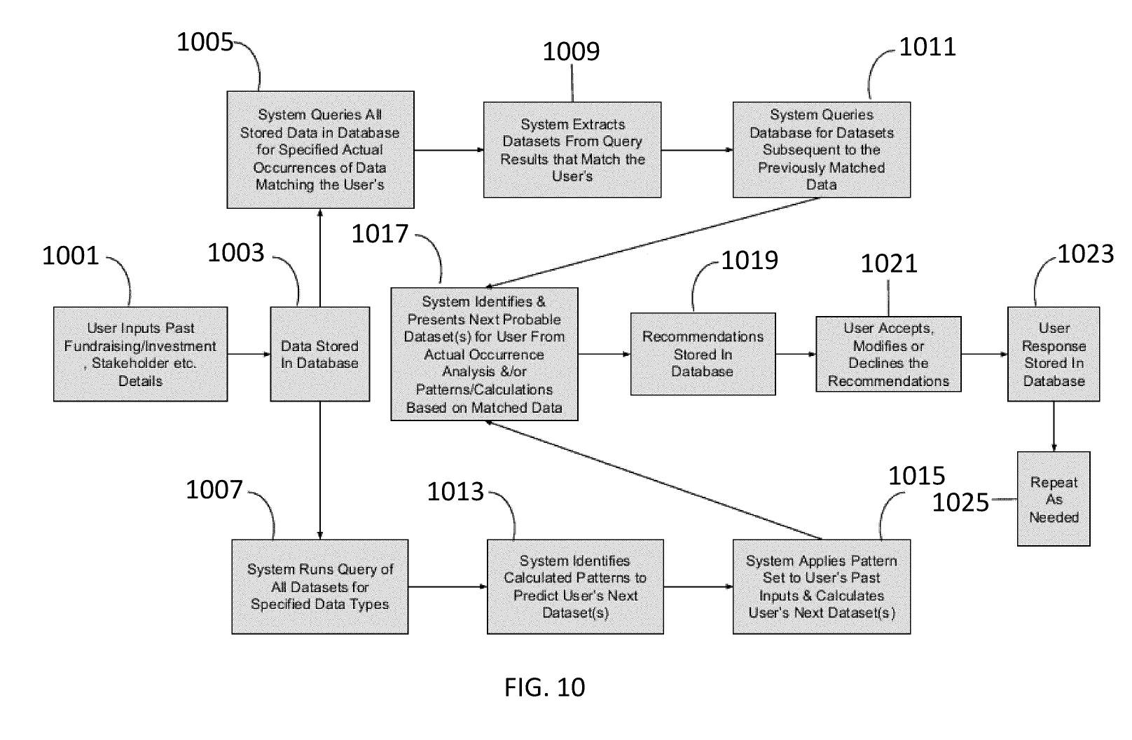

The deal term prediction and recommendation module 222 may perform the method illustrated by the example flow diagram in FIG. 10. At block 1001, the system receives a user input, which is stored in a database (e.g., database 18) at block 1003. As explained in greater detail below, the system may query data stored in a database (e.g., database 18) for actual occurrences of data matching the user input at block 1005, or the system may query data stored in a database (e.g., database 18) for specified data types based on pattern recognition at block 1007.

If the system searches for actual occurrences at block 1005, the system queries all gathered data and extracts the results that match the user input at block 1009. Once the actual occurrences are identified, the system queries the database made up of the actual occurrences and extracts the appropriate information based on the user objective at block 1011. If the system uses pattern recognition at block 1007, the system identifies patterns to predict a result pertaining to the user situation at block 1013 and applies the pattern set to the user inputs to provide the prediction at block 1015. For example, the system may employ machine learning to identify relevant patterns. In this case, the system may be trained with a set of patterns to learn patterns of various situations. The system may employ various models to perform the learning (e.g., neural networks, mathematical/statistical models, classifiers, etc.).

Regardless whether the systems develops its predictions based on actual occurrences or pattern analysis, the prediction information is identified at block 1017 and stored in a database (e.g., database 18) at block 1019. The user may provide a response (e.g., accept, modify, decline, etc.) to the recommendation at block 1021. At block 1023, the user response is stored in a database (e.g., database 18). As illustrated by block 1025, the user may repeat this process by providing another user input at block 1001, and continuing the process as described above. The user may continue this process to, for example, develop an exit strategy.

For example, the system may employ machine learning to determine recommendations for a user. In this case, the recommendation selected by the user may be stored, and/or metrics and/or attributes of the selected information (e.g., success, goal attained, etc.) may be tracked. This data may be processed to learn preferences for the user. Further, the system may employ machine learning to provide additional metrics and/or attributes based on the metrics and/or attributes used for the selected recommendation. The system may employ various models to perform the learning (e.g., neural networks, mathematical/statistical models, classifiers, etc.). By way of example, a recommendation may be selected, but for some reason, may not produce a desired outcome. The system may learn these aspects and employ them to determine future recommendations for the user.

Scenario prediction and recommendation module 224 enables a user to model fundraising/investment and/or exit scenarios. The system incorporates predictive analytics to efficiently predict potential future outcomes (e.g., future investment amounts raised, future types of investment raised, future dilution, future payouts, etc.). The scenario prediction and recommendation module 224 may repeat a series of predictions through a number of investment rounds specified by the user or through an exit (e.g., initial public offering, acquisition, etc.) to provide the final predicted output(s).

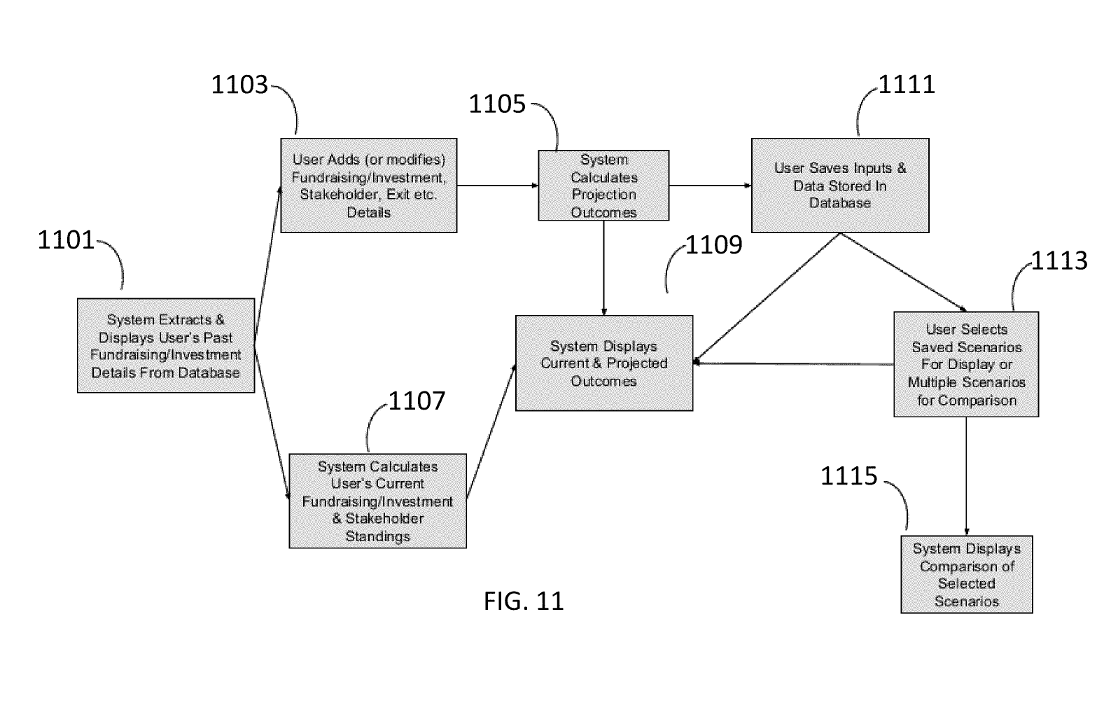

The scenario and recommendation module 224 may construct model scenarios to allow a user to determine the impact of future decisions related to capitalization and/or stakeholder needs, as illustrated by the example flow diagram in FIG. 11. In this flow diagram, the system already has access to information relating to past user fundraising/investment behavior. Using this information, the scenario and recommendation module 224 may pre-populate the scenario user display at block 1101. The user may add or modify the pre-populated information at block 1103 before the scenario and recommendation module 224 calculates a prediction at block 1105.

The scenario and recommendation module 224 also calculates current user information (e.g., current fundraising/investment information, current stakeholder standings, etc.) at block 1107. At block 1109, the system displays the current user information and the scenario prediction information. The user may save the current user information and/or the scenario prediction information to a database (e.g., database 18) at block 1111. The user may subsequently retrieve the current user information and/or the scenario prediction information at block 1113 for display at block 1109. The user may also retrieve prediction information for multiple scenarios (e.g., to compare multiple scenarios) at block 1113 for display at block 1115.

In an embodiment, the system predicts, via the document prediction and recommendation module 226, documents that may be helpful for a user at a particular stage of a capitalization process. For example, if the system determines that the user might wish to extend the maturity for a convertible note, document prediction and recommendation module 226 may prepare the associated documents (e.g., legal forms) for the user to extend the convertible note maturity date. The documents may be automatically pre-filled by the system. The user may accept, decline, or modify the pre-filled documents. The system may maintain a library of suggested documents, which the user may access at later times. The user may view a timeline of potentially useful documents, which may be helpful for planning purposes.

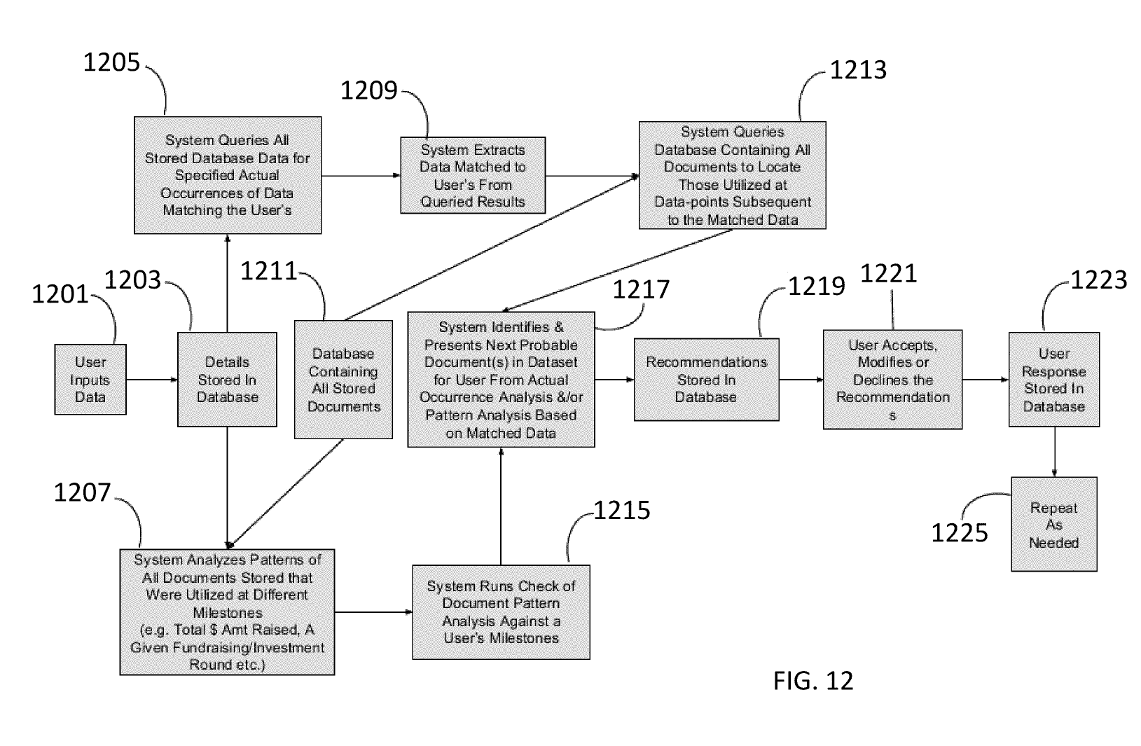

Document prediction and recommendation module 226 provides predictive recommendations for documents that are potentially relevant to the user, as illustrated by the example flow diagram in FIG. 12. At block 1201, the system receives a user input, which is stored in a database (e.g., database 18) at block 1203. As explained in greater detail below, the system may query data stored in a database (e.g., database 18) for actual occurrences of data matching the user input at block 1205, or the system may query data stored in a database (e.g., database 18) for specified data types based on pattern recognition at block 1207.

If the document prediction and recommendation module 226 carries out operations based on actual occurrences, it extracts data that matches given parameters relative to the user input at block 1209. Once the corresponding data is identified, the system queries, at block 1213, a database (e.g., database 18) at block 1211 for documents that other users have utilized at subsequent points in a corresponding capitalization process. In other words, the selected documents are anticipated to be helpful for the user at a particular stage in a capitalization process because other users in similar situations have used the documents at analogous stages in capitalization processes.

If the document prediction and recommendation module 226 carries out operations based on pattern recognition, the system queries, at block 1207, a database (e.g., database 18) at block 1211. At block 1215, the data is analyzed to identify patterns in the documents that are utilized at various points in capitalization processes (e.g., investment rounds, convertible note maturities, share vesting, etc.). For example, the system may employ machine learning to identify relevant patterns. In this case, the system may be trained with a set of patterns to learn patterns of various situations. The system may employ various models to perform the learning (e.g., neural networks, mathematical/statistical models, classifiers, etc.).

Regardless whether the systems develops its predictions based on actual occurrences or pattern analysis, the predicted document(s) is/are identified at block 1217 and stored in a database (e.g., database 18) at block 1219. The user may provide a response (e.g., accept, modify, decline, etc.) to the recommendation at block 1221. At block 1223, the user response is stored in a database (e.g., database 18). As illustrated by block 1225, the user may repeat this process by providing another user input at block 1201, and continuing the process as described above. The user may continue this process to, for example, view documents that may be required in the future, all the way through a potential exit. For example, the system may employ machine learning to determine document recommendations for a user. In this case, the document recommendation selected by the user may be stored, and/or metrics and/or attributes of the selected document recommendation (e.g., success, goal attained, etc.) may be tracked. This data may be processed to learn preferences for the user. Further, the system may employ machine learning to provide additional metrics and/or attributes based on the metrics and/or attributes used for the selected document recommendation. The system may employ various models to perform the learning (e.g., neural networks, mathematical/statistical models, classifiers, etc.). By way of example, a document recommendation may be selected, but for some reason, may not produce a desired outcome. The system may learn these aspects and employ them to determine future document recommendations for the user.

As discussed above, there are two primary manners by which the system generates predictive recommendations: actual occurrences and pattern recognition. With regard to the former, the system analyzes occurrences of actual data (e.g., data from other users), determines which actual data is relevant to the particular user situation, and provides that data to the user in a useful manner (e.g., recommending details for the next potential investment round, a pre-filled legal document that the user may require to carry out a particular capitalization strategy, etc.). With regard to the latter, the system generates a predictive recommendation by analyzing patterns in data relevant to the user, generating a prediction (e.g., likely deal terms or exit strategy outcome), and presenting the recommendation to the user. An example situation is provided as follows to more fully describe predictive recommendation generation.

In this example situation, a user currently on a fourth investment round has raised convertible debt for each of the three previous investment rounds for a total convertible debt amount raised of two million dollars. The user wishes to determine which type of investment (e.g., convertible debt or equity), and the general amount, that is commonly raised.

Table 1 illustrates the results of the three previous investment rounds for the user.

TABLE 1

| Round 1 | Round 1 | Round 2 | Round 2 | Round 3 | Round 3 |
|---|---|---|---|---|---|
| Investment | Investment | Investment | Investment | Investment | Investment |
| Type | Amount | Type | Amount | Type | Amount |
| Convertible Debt | $250,000 | Convertible Debt | $500,000 | Convertible Debt | $1,250,000 |

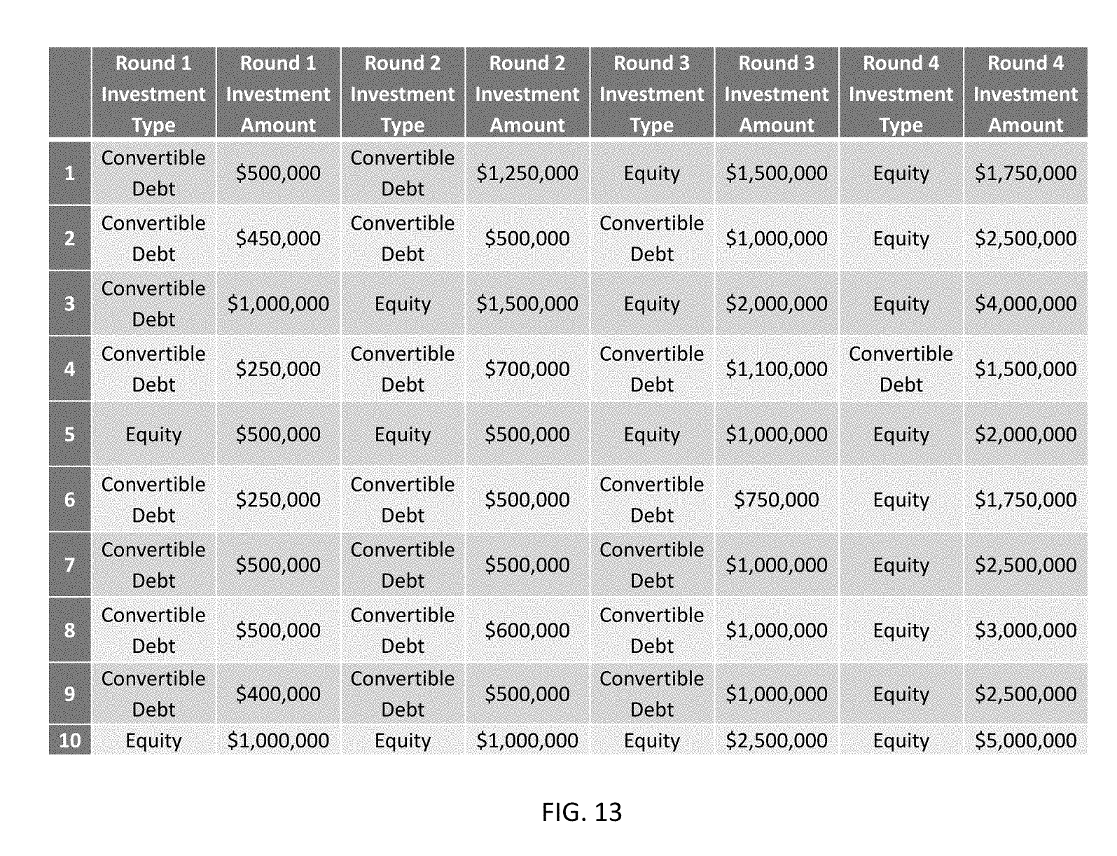

Because the user is currently on the fourth investment round, the system extracts data involving ten other users who raised funds over the course of four investment rounds. This data is illustrated in FIG. 13 as Table 2.

### Example 1—Actual Occurrence

Example 1 illustrates a method of generating a prediction for the user round four investment based on actual occurrences as provided in Table 2 (FIG. 13). First, the system examines the data for occurrences where the investment type for the first three investment rounds included convertible debt. The system narrows the occurrences based on the aggregate amount collected over the first three rounds. In this example, the system narrows the occurrences to aggregate amounts within five percent of the user aggregate amount (i.e., between $1,900,000 and $2,100,000), as illustrated in Table 3.

TABLE 3

| | Aggregate | Round 4 Investment | Round 4 Investment |
|---|---|---|---|
| | Value | Type | Amount |
| 2 | $1,950,000 | Equity | $2,500,000 |
| 4 | $2,050,000 | Convertible Debt | $1,500,000 |
| 6 | $1,500,000 | Equity | $1,750,000 |
| 7 | $2,000,000 | Equity | $2,500,000 |
| 8 | $2,100,000 | Equity | $3,000,000 |
| 9 | $1,900,000 | Equity | $2,500,000 |

Based on the information in Table 3, the system may calculate and report the following information:
83.33% of subsequent (i.e., Round 4) investment rounds involve equity-type investments.
The median investment amount raised in the subsequent investment rounds is $2,500,000.
The average investment amount raised in the subsequent investment rounds is $2,450,000.
The subsequent round investment amounts range from $1,750,000 to $3,000,000.

The user may utilize this prediction recommendation information to, for example, determine that it would be reasonably expected to pursue an equity-type investment of approximately $2,500,000.

### Example 2—Pattern Recognition

Example 2 illustrates a method of generating a prediction for the user round four investment based on pattern inference. In this example, the system runs a continuous query to extract data relating to the change in the investment amount from one round to the next (e.g., investment round one to investment round two, investment round two to investment round three, etc.). The system then separates the data into appropriate categories to perform calculations on a per-round and/or aggregate basis.

### Example 2A—Per-Round Basis

Performing calculations on a per-round basis involves predicting a subsequent round (e.g., the fourth round) based on the average increase per round. The data is further analyzed based on the investment type from one round to the next (e.g., one round may involve a convertible debt-type investment, and the subsequent round may involve an equity-type investment). In this example, the system evaluates the data provided in Table 2 (FIG. 13) as follows.

The system extracts data corresponding to cases in which the previous and subsequent investments rounds both involve convertible debt-type investments (e.g., user one, rounds one and two). The system calculates the average investment increase (e.g., the difference between the investment amount of the subsequent round and the investment amount of the previous round). For rounds one and two, the average investment amounts are $407,142.86 and $650,000, respectively. This corresponds to an average increase of $242,857.14, or 59.6491%. For rounds two and three, the average investment amounts are $550,000 and $975,000, respectively. This corresponds to an average increase of $425,000, or 77.2727%. For rounds three and four, the average investments are $1,100,000 and $1,500,000, respectively. This corresponds to an average increase of $400,000, or 36.3637%.

The system also extracts data corresponding to cases in which the previous round involves convertible debt-type investments and the subsequent round involves equity-type investments (e.g., user two, rounds three and four). The system then calculates the average investment increase. For rounds one and two, the average investment amounts are $1,000,000 and $1,500,000, respectively. This corresponds to an average increase of $500,000, or 50%. For rounds two and three, the average investment amounts are $1,250,000 and $1,500,000, respectively. This corresponds to an average increase of $250,000, or 20%. For rounds three and four, the average investment amounts are $950,000 and $2,450,000, respectively. This corresponds to an average increase of $1,500,000, or 157.8947%.

The system also extracts data corresponding to cases in which the previous and subsequent investments rounds both involve equity-type investments (e.g., user five, rounds two and three). The system calculates the average investment increase. For rounds one and two, the average investment amounts are $750,000 and $1,250,000, respectively. This corresponds to an average increase of $500,000, or 66.6667%. For rounds two and three, the average investment amounts are $1,166,700 and $1,833,400, respectively. This corresponds to an average increase of $666,700, or 57.144%. For rounds three and four, the average investment amounts are $1,750,000 and $3,187,500, respectively. This corresponds to an average increase of $1,437,500, or 82.1429%.

The system matches these data points to the user. For instance, the system may utilize “actual occurrence” methodology, as described above, to determine that the user round four will likely include an equity-type investment. Thus, the system determines that the previous user investment round (i.e., user round three) involved a convertible debt-type investment, and the subsequent investment round (i.e., user round four) will involve an equity-type investment. The system uses the data extracted from Table 2 (FIG. 13), specifically data involving round three convertible debt-type investments and round four equity-type investments, to predict that the user will raise $3,223,683.75 in equity during investment round four.

The system arrives at the amount of $3,223,683.75 as follows. As illustrated in Table 1 above, the user raised $1,250,000 in the user investment round three. Also, as described above, the system determined that the percentage investment increase from a convertible debt-type round three to an equity-type round four 157.8947%. The system calculates that 157.8947% of $1,250,000 is $1,973,683.75, which corresponds to the expected investment increase from user investment round three to user investment round four. The system adds $1,973,683.75 to $1,250,000 to generate a prediction that the user is likely to raise $3,223,683.75 in equity during investment round four.

The system may employ machine learning to determine patterns and generate the predictions for a user. In this case, the system may be trained with a set of patterns to learn the patterns for various scenarios and determine the predictions. Further, the system may employ machine learning to provide additional metrics and/or attributes based on the metrics and/or attributes for prior predictions (e.g., actual results relative to predicted results). The system may employ various models to perform the learning (e.g., neural networks, mathematical/statistical models, classifiers, etc.).

### Example 2B—Aggregate Basis

Performing calculations on an aggregate basis is similar to performing calculations on a per-round basis as described above. However, unlike in Example 2A, the investment round number is not taken into consideration. That is, this method generates predictions based on the average increase over all rounds. In this example, the system evaluates the data provided in Table 2 (FIG. 13) as follows.

The system extracts data corresponding to cases in which the previous and subsequent investments rounds both involve convertible debt-type investments. The system then calculates the average investment increase over all rounds. In this example, the average percentage investment increase is 57.6183%.

The system also extracts data corresponding to cases in which the previous round involves convertible debt-type investments and the subsequent round involves equity-type investments. The system then calculates the average investment increase over all rounds. In this example, the average percentage investment increase is 75.9649%.

The system extracts data corresponding to cases in which the previous and subsequent investments rounds both involve equity-type investments. The system calculates the average investment increase over all rounds. In this example, the average percentage investment increase is 68.6512%.

The system matches these data points to the user. For instance, the system may utilize “actual occurrence” methodology, as described above, to determine that the user round four will likely include an equity-type investment. Thus, the system determines that the previous user investment round (i.e., user round three) involved a convertible debt-type investment, and the subsequent investment round (i.e., user round four) will involve an equity-type investment. Similar to Example 2A, the system uses the data extracted from Table 2 (FIG. 13), specifically data involving previous convertible debt-type investments and subsequent equity-type investments, to predict that the user will raise $2,199,561.25 in equity during investment round four.

The system arrives at the amount of $2,199,561.25 as follows. As illustrated in Table 1 above, the user raised $1,250,000 in the user investment round three. Also, as described above, the system determined that the percentage investment increase from a convertible debt-type to an equity-type round four is 75.9649%. The system calculates that 75.9649% of $1,250,000 is $949,561.25, which corresponds to the expected investment increase from user investment round three to user investment round four. The system adds $949,561.25 to $1,250,000 to generate a prediction that the user is likely to raise $2,199,561.25 in equity during investment round four.

The system may employ machine learning to determine patterns and generate the predictions for a user. In this case, the system may be trained with a set of patterns to learn the patterns for various scenarios and determine the predictions. Further, the system may employ machine learning to provide additional metrics and/or attributes based on the metrics and/or attributes for prior predictions (e.g., actual results relative to predicted results). The system may employ various models to perform the learning (e.g., neural networks, mathematical/statistical models, classifiers, etc.).

Thus, the system may provide the user with varying predictions, depending on the particular method the system utilizes. If “actual occurrence” methodology is used as described in Example 1, the system predicts the user is likely to generate $2,500,000 in equity in investment round four. If “pattern recognition” is used on a per-round basis as described in Example 2A, the system predicts the user is likely to generate $3,223,683.75 in equity in investment round four. If “pattern recognition” is used on an aggregate basis as described in Example 2B, the system predicts the user is likely to generate $2,199,561.25 in equity in investment round four.

The system may use these methods alone or in combination, and may use multiple methods in parallel to provide the user with a plurality of predicted recommendations. As described above, these methods may be used to predict deal terms, scenarios, and/or documents. The actual occurrence and pattern recognition methodologies apply similarly to deal terms, scenarios, and/or documents. In the case of document prediction using pattern recognition, the system may search for patterns of documents that are utilized at various points in a capitalization process, instead of searching for numerical patterns.

The system may utilize other patterns than those in the examples provided above. For example, the system may match the user data with other data based on the percent or dollar increase per round. For instance, if the user investment increased by 50% from a first investment round to a second investment round, and 100% from the second round investment to a third investment round, the system may search for other data involving similar increases at each round, determine the performance of the other data during a fourth round of investments, and provide the performance in the form of a prediction. The system may perform the analysis based on dollar amounts rather than percentages.

The system may also identify exact matches between the user data and the other data to make recommendations based on inferences from the other data. The system may also allow the user to request certain recommendations based on an objection (e.g., the user may request a recommendation for corresponding fourth round deal terms, if the user has predetermined in would be an equity round). The system may employ machine learning to determine recommendations for the user. In this case, the recommendation selected and/or objection made by the user may be stored, and/or metrics and/or attributes of the selected recommendation (e.g., success, goal attained, etc.) may be tracked. This data may be processed to learn preferences for the user. Further, the system may employ machine learning to provide additional metrics and/or attributes based on the metrics and/or attributes used for the selected recommendation. The system may employ various models to perform the learning (e.g., neural networks, mathematical/statistical models, classifiers, etc.).

An invention embodiment includes storage for refining/isolating the appropriate reference data for each user for correlation reference, and further includes storage for refining/isolating aggregate (e.g., global) data to be correlated with user reference data. In addition, provided herein storage for refining/isolating the correlated aggregate data for each user, which may be used to identify specific recommendations to be stored for individual users.

The system storage and data refinement/isolation may allow retrieval queries to be very specific and easily filtered, thereby minimizing the number of database interactions and amount of data that is transmitted. The storage may update the refined/isolated data as each new dataset is input, thus further minimizing the amount data that is processed and enhancing the process by which the user receives recommendations.

The system also includes storage for user interaction with system recommendations (e.g. validating, accepting, declining, altering, etc.). This storage method enables the system to better filter this data and apply weightings/ratings/measures/etc. to certain datasets, if necessary. As users interact with the recommendations (directly, by entering data that validates or differs from the recommendations, etc.), the system learns about the accuracy of those recommendations. This ability to learn from the user data and interactions enables the system to generate more accurate recommendations and also to better define/narrow the identification parameters and/or minimize the calculations needed, thereby improving the optimization of the system processing. For example, as described above, the system may determine recommendations to provide a user who has raised $2,000,000 over three past convertible debt rounds by filtering all data to identify instances where $2,000,000+/−10% (i.e., $1.8 million-$2.2 million) was raised in three previous convertible debt rounds. The system may then examine the fourth round details for the identified data to learn that, for example, an average of $2,500,000 in equity (instead of convertible debt) was raised (and all the additional corresponding terms).

Continuing with this example, as users interact with data, or input actual results for the fourth investment round, the system may learn the actual ranges of investment amounts raised over the previous three rounds. For instance, the system may examine all instances where $2,500,000 in equity was raised at the fourth investment round, and then learn the actual range of investments for the previous three rounds. If the system found that the range of total investment amounts was actually $1.9 million-$2.1 million, the system may narrow the uncertainty or margin of error/safety. In this example, +/−10% may be reduced to +/−5%. These new pattern identifications and/or calculations may be cross validated with others, ultimately refining and reducing the amount of data to be processed, further enhancing the processing and accuracy of future recommendations.

The system may employ machine learning models to determine the range. In this case, the system may be trained with a data set to learn to determine the ranges for various scenarios and/or adjust the margin of error/safety. The system may employ various models to perform the learning (e.g., neural networks, mathematical/statistical models, classifiers, etc.).

The storage methods and data refinement systems enable the system to minimize and automatically improve the processing requirements for queries and calculations. For example, the system may establish a database table including the only most recent recommendations for users, separate from the aggregate user data. Upon an initial user entry to the system, a check may be run against the aggregate system data to identify the patterns and/or run the calculations to save the initial set of recommendations to be stored in the segregated recommendations table. As any additional data is input and stored in the system database (by any user), the system may run a check to identify the user recommendations that the new data may impact. Once the impacted recommendations have been identified, the necessary pattern identifications may be made and calculations run, at which point the updated recommendation data may be stored in the segregated recommendations table. Segregating and continuously updating the user recommendation data as new data is input allows for improved processing for the user. The isolation of the recommendation data minimizes the amount of data queried, and continuously performing the pattern identification and/or calculations (e.g., when new data is input) minimizes the data processing and calculations done, thereby optimizing the user processing.

It will be appreciated that the embodiments described above and illustrated in the drawings represent only a few of the many ways of implementing computerized machine learning based recommendations.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, capitalization management module 16, etc.). These systems may include any types of monitors and input devices (e.g., keyboard, mouse, voice recognition, etc.) to enter and/or view information.

It is to be understood that the software (e.g., capitalization management module 16) of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments (e.g., capitalization management module 16) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., documents). The database system may be implemented by any number of any conventional or other databases, data stores or storage structures (e.g., files, databases, data structures, data or other repositories, etc.) to store information (e.g., documents). The database system may be included within or coupled to the server and/or client systems. The database systems and/or storage structures may be remote from or local to the computer or other processing systems, and may store any desired data (e.g., user capitalization data).

The present invention embodiments may employ any number of any type of user interface (e.g., Graphical User Interface (GUI), command-line, prompt, etc.) for obtaining or providing information (e.g., user capitalization data), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for any method of generating recommendations by machine learning for any scenario (e.g., user capitalization strategy, etc.). The system may further perform actions pertaining to, or implementing, a recommendation (e.g., generate documents, perform electronic transactions, generate and/or transit communications, control processing to perform further queries, machine learning, etc.), and may dynamically update or adjust the recommendation and actions as new data is received. For example, during implementation of a recommendation, the goal progress may be tracked and the recommendation and/or actions adjusted based on the goal or objective status.

What is claimed is:

1. A method of generating a machine learning based recommendation comprising:
receiving, via a processor, user data pertaining to previous user decisions pertaining to capitalization;
automatically querying, via the processor, for data that is similar to the user data;
receiving, via the processor, an objective that constrains a desired strategy for capitalization; and
automatically analyzing the similar user data and the objective to generate the recommendation for the desired strategy based on machine learning from the similar user data.

2. The method of claim 1, wherein the recommendation includes a term of a deal relating to the desired strategy.

3. The method of claim 1, wherein the recommendation includes a result of a projected scenario relating to the desired strategy.

4. The method of claim 1, wherein the recommendation includes a document relating to the desired strategy.

5. The method of claim 1, further comprising enabling a user to accept, modify, or decline the recommendation.

6. The method of claim 1, wherein automatically analyzing includes predicting, based on an average increase per previous investment round included in the similar user data, an investment amount for a user to raise during a subsequent investment round.

7. The method of claim 1, wherein automatically analyzing includes predicting, based on an average increase over all previous investment rounds included in the similar user data, an investment amount for a user to raise during a subsequent investment round.

8. A system for generating a machine learning based recommendation comprising:
at least one processor configured to:
receive user data pertaining to previous user decisions pertaining to capitalization;
automatically query for data that is similar to the user data;
receive an objective that constrains a desired strategy for capitalization; and
automatically analyze the similar user data and the objective to generate the recommendation for the desired strategy based on machine learning from the similar user data.

9. The system of claim 8, wherein the recommendation includes a term of a deal relating to the desired strategy.

10. The system claim 8, wherein the recommendation includes one of a result of a projected scenario relating to the desired strategy and a document relating to the desired strategy.

11. The system of claim 8, wherein the at least one processor is further configured to enable a user to accept, modify, or decline the recommendation.

12. The system of claim 8, wherein automatically analyzing includes predicting, based on an average increase per previous investment round included in the similar user data, an investment amount for a user to raise during a subsequent investment round.

13. The system of claim 8, wherein automatically analyzing includes predicting, based on an average increase over all previous investment rounds included in the similar user data, an investment amount for a user to raise during a subsequent investment round.

14. A computer program product comprising:
a non-transitory computer readable medium having program code stored thereon for generating a machine learning based recommendation, the program code causing at least one processor to:
receive user data pertaining to previous user decisions pertaining to capitalization;
automatically query for data that is similar to the user data;
receive an objective that constrains a desired strategy for capitalization; and
automatically analyze the similar user data and the objective to generate the recommendation for the desired strategy based on machine learning from the similar user data.

15. The computer program product of claim 14, wherein the recommendation includes a term of a deal relating to the desired strategy.

16. The computer program product of claim 14, wherein the recommendation includes a result of a projected scenario relating to the desired strategy.

17. The computer program product of claim 14, wherein the recommendation includes a document relating to the desired strategy.

18. The computer program product of claim 14, wherein the program code further causes the at least one processor to enable a user to accept, modify, or decline the recommendation.

19. The computer program product of claim 14, wherein automatically analyzing includes predicting, based on an average increase per previous investment round included in the similar user data, an investment amount for a user to raise during a subsequent investment round.

20. The computer program product of claim 14, wherein automatically analyzing includes predicting, based on an average increase over all previous investment rounds included in the similar user data, an investment amount for a user to raise during a subsequent investment round.
